(19) United States
(12) Patent Application Publication
(10) Pub. No.: US 2024/0286839 A1
(43) Pub. Date: Aug. 29, 2024

(54) DISTRIBUTOR SYSTEM AND METHOD FOR CONVEYING GOODS IN A STORAGE AND ORDER-PICKING SYSTEM

(71) Applicant: TGW Logistics Group GmbH, Marchtrenk (AT)

(72) Inventors: Timothy LINDLEY, Schwerte (DE); Gerald KETTLGRUBER, Linz (AT)

(21) Appl. No.: 18/573,862

(22) PCT Filed: Jun. 23, 2022
(86) PCT No.: PCT/AT2022/060211

§ 371 Date: Dec. 22, 2023

(30) Foreign Application Priority Data
Jun. 24, 2021 (AT) A 50522/2021

(51) Int. Cl. B65G 1/137; B65G 47/69

(52) U.S. Cl. CPC B65G 1/1376; B65G 47/69

(57) ABSTRACT

A distributor system (1) for conveying articles with loading aids includes a provisioning system (2), a first distributor device (3a), a first buffer device (4a) and a target system (5), wherein the first distributor device (3a) has a distributor line (32a), along which the loading aids can be conveyed, and a first distributor infeed line (31a), which is connected, in terms of conveyance, to the provisioning system (2), and wherein the first distributor device (3a) is connected, in terms of conveyance, to the first buffer device (4a) and to the target system (5), wherein the first distributor device (3a) has a second distributor infeed line (33a), which is connected, in terms of conveyance, the buffer outfeed line (43a) of the first buffer device (4a). Methods for provisioning articles included in an order are also disclosed.

### RELATED APPLICATIONS

This application is a national stage under 35 U.S.C. § 371 of International Application No. PCT/AT2022/060211, filed Jun. 23, 2022, which claims priority of Austrian Patent Application No. A 50522/2021, filed Jun. 24, 2021.

### FIELD OF THE INVENTION

The present disclosure relates to a distributor system for conveying articles with loading aids in a picking system and to a method for provisioning at least one article and/or articles included in an order in a target system of a picking system by a distributor system for conveying the articles with loading aids.

### BACKGROUND

Known from the prior art are distributor systems for distributing articles in a picking system. As a rule, such systems comprise a conveying system for conveying articles from a storage region to a buffer device, from the buffer device to a sorting device and further to a workstation.

EP 3 666 690 A1 and WO 2019/028485 A1 disclose a distributor system for conveying articles with loading aids. Here, the distributor system is configured to take over articles from a provisioning system and supply them to a buffer device via a distributor device. Subsequently, the articles are supplied from the buffer device to a target system.

EP 3 680 200 A1 discloses a distributor system for conveying articles with loading aids, in which the articles are supplied to a buffer device via buffer infeed lines and transported away to a target system via buffer outfeed lines.

According to EP 2 789 555 A1, the distributor system is configured to take over articles from a provisioning system and supply them to a buffer device via a distributor device. Here, the articles can be discharged from the buffer device and supplied to a target system via another distributor device.

DE 10 2018 114 026 A1 discloses a distributor system for conveying articles with loading aids. Here, articles can be supplied from a provisioning system to a distributor device via a distributor infeed line. Further, the articles can be supplied to a target system. Furthermore, a buffer device for temporarily storing the articles is provided. However, the articles cannot be transported immediately to the target system from the buffer device, as the buffer outfeed line is arranged downstream, in a conveying direction, of any and all lines leading towards the target system.

Known from EP 2 581 329 A1 is a distributor system with a provisioning system comprising a loading station. Here, the loading station is connected to two buffer devices via a conveying system. Loading aids, in turn, are conveyed from the buffer devices into a target system via another conveying system. In this distributor system, the loading aids can be discharged from the respective buffer device and conveyed back to into the same buffer device via a carousel. What is more, the plant layout disclosed in EP 2 581 329 A1 results in the fact that, in order to arrive at the target system, a loading aid must be conveyed through one of the two buffer devices in any case.

A similar plant layout is known from WO 2019/016120 A1, wherein the provisioning system comprises two loading stations. The conveyance of the articles between the individual parts of the plant is done via a plurality of distributor lines configured as a circulation circuit. The loading stations are thus connected to one buffer device each, respectively via a circulation circuit. Similarly, the buffer devices are connected to a target system via at least one other circulation circuit. The disclosed plant layout further results in a hierarchy of the components, so that, for example, while loading aids can be transferred from the first buffer device into the second buffer device via a second circulation circuit or can be resupplied to the first buffer device via this very second circulation circuit, the distributor system of WO 2019/016120 A1 allows a conveyance from the second buffer device merely into the target system, optionally via another circulation circuit. Therefore, the circulation circuits are each assigned to specific plant components, whereby the layout is limited in terms of flexibility. With increasing complexity of the plant, a higher number of circulation circuits will be required.

Known from WO 2012/163780 A1 is a distributor system with two buffer devices. A circulation circuit, along which articles can be conveyed, enables the articles to be distributed to the buffer devices. To this end, the buffer devices are arranged inside the circulation circuit and immediately adjoin same. However, this results in the disadvantage that the circulation circuit must surround the buffer devices in order to be able to forward articles to same on the one hand and discharge them from same on the other hand. Therefore, an increasing number of buffer devices will also result in an increasing need for space as well as an extended circulation time in the circulation circuit.

A need remains for an improved distributor system as well as an improved method for provisioning articles in a target system, with which articles can be flexibly distributed in the picking system and which can be operated and/or carried out efficiently.

### SUMMARY

A distributor system according to the present disclosure comprises a provisioning system for provisioning the articles with loading aids, a first distributor device, arranged downstream of the provisioning system, for distributing the loading aids, a first buffer device for temporarily storing the loading aids, which comprises a buffer infeed line and a buffer outfeed line and at least one buffer region arranged between the buffer infeed line and the buffer outfeed line, and a target system for processing orders that is arranged downstream of the first distributor device, wherein the first distributor device comprises a distributor line, along which the loading aids can be conveyed, and a first distributor infeed line, which is connected, in terms of conveyance, to the provisioning system and is adapted to convey the loading aids from the provisioning system to the distributor line, and wherein the first distributor device is connected, in terms of conveyance, to the buffer infeed line of the first buffer device and is adapted to convey the loading aids from the distributor line to the first buffer device, and is connected, in terms of conveyance, to the target system and is adapted to convey the loading aids from the distributor line to the target system, wherein the first distributor device has a second distributor infeed line, which is connected, in terms of conveyance, to the buffer outfeed line of the first buffer device and is adapted to convey the loading aids from the first buffer device to the distributor line.

One advantage that may be achieved with systems according to the present disclosure is that the articles can be discharged from the buffer device and conveyed back into the distributor line, which results in a particularly flexible distributor system. Furthermore, the buffer device can be arranged physically separate from the distributor line, which enables in particular an increased spatial flexibility when installing such a distributor system and/or a picking system with such a distributor system. Finally, this enables a particularly flexible operation of the distributor system. For example, articles can be conveyed optionally into the buffer device or along the distributor line past the buffer device, in the sense of a material flow. Also, articles that are conveyed into the buffer device can be merged again, along the distributor line, with articles that are conveyed past the buffer device in order to complete orders, for example.

In the target system, orders can be processed. To this end, the target system can comprise a workstation, or a plurality of (different) workstations, in particular a picking station, a packing station, a shipping station or suchlike.

Furthermore, it is favorable if the distributor system comprises an electronic order management system for acquiring the orders.

To convey the articles and/or the loading aids inside the distributor system, in particular along the conveyor lines, the distributor system can comprise a conveying system. Here, the conveyor lines can each be provisioned by a conveying system. The conveying system is preferably configured as an overhead conveying system or as a conveying system that is distinct from the overhead conveying system, in particular as a ground-based conveying system, for example as a roller conveying system or as a belt conveying system. Here, each of the conveying systems are stationary. As an alternative or in addition to this, the conveying system can have a mobile conveying system, for example in sections, which comprises in particular autonomously displaceable conveying vehicles. Such conveying vehicles can be controlled by a superordinate master computer. Such conveying vehicles are known to the skilled person by the terms “automated guided vehicles” (AGVs in short) or “autonomous mobile robots” (AMRs in short). Here, it is provided in particular that the lines and/or conveyor lines, such as, for example, the first and second distributor infeed line, the distributor line, the buffer infeed line, the buffer outfeed line and/or other lines and/or conveyor lines described in more detail below, are provisioned by the conveying system.

Advantageously, the articles in the distributor system are provisioned with loading aids, in particular in or on loading aids, and/or conveyed with loading aids, in particular in or on loading aids. On the one hand, the loading aids can be configured for use with the overhead conveying system. A possible embodiment of such an overhead conveying system is shown, for example, in WO 2020/160585 A2. Such loading aids are generally known and comprise, for example, hanging bags, coat hangers, transport carriers for hooking in hanging articles or suchlike. On the other hand, the loading aids can be configured for use with the conveying system that is distinct from the overhead conveying system. Such loading aids are also generally known and comprise, for example, containers, cardboard boxes, trays and suchlike. The loading aids can also be configured as bags, for example as so-called polybags.

It is advantageous if the distributor system comprises a first distributor outfeed line, which connects, in terms of conveyance, the distributor line, in particular the distributor line of the first distributor device and/or the distributor line(s) of other optional distributor devices described below, and the buffer infeed line.

Furthermore, it is favorable if the distributor system comprises a second distributor outfeed line, which connects, in terms of conveyance, the distributor line, in particular the distributor line of the first distributor device and/or the distributor line(s) of other optional distributor devices described below, and the target system.

The first distributor device is preferably operated in an automated manner. To this end, the distributor line, the first distributor infeed line and/or the second distributor infeed line can comprise a conveying system, in particular an overhead conveying system.

Preferably, it is provided that the buffer region has a buffer line, along which the articles can be moved with the loading aids. This ensures that the buffer device is configured with mobile buffer locations. Mobile buffer locations can be realized, for example, on an overhead conveying system described above. Alternatively, the buffer region can have a plurality of immobile buffer locations. Immobile buffer locations can be realized, for example, as storage locations in storage racks, as receiving locations along a buffer line or suchlike. Preferably, the buffer infeed line is arranged such that it leads towards the buffer region. Analogously, the buffer outfeed line is arranged such that it leads away from the buffer region.

The first buffer device is preferably operated in an automated manner. To this end, the buffer region, the buffer infeed line and/or the buffer outfeed line can comprise a conveying system, in particular an overhead conveying system.

A process in the picking system will usually run in a process direction (material flow direction) from the provisioning of the articles in the provisioning system, comprising, for example, a storage of the articles in a storage region, up to a processing of orders in the target system, comprising, for example, a shipping of the articles as a final step. The distributor system is preferably adapted such that the articles and/or the loading aids can be conveyed through the distributor system in the process direction, in particular by means of the conveying system.

Expediently, the provisioning system, the buffer device and the target system are arranged in succession in a process direction. The distributor device is preferably arranged along the first distributor infeed line between the provisioning system and the buffer device in a process direction and along the second distributor infeed line between the buffer device and the target system in a process direction.

It is favorable if the provisioning system comprises at least one storage region and at least one loading station. Therefore, the articles can be loaded into or onto the loading aid at the loading station.

Here, the storage region is preferably configured to store the articles, with or without the loading aids described above. The storage region can be provisioned by an article store, for example. The storage region can comprise storage racks installed in a stationary manner with storage locations arranged next to one another in rack levels located on top of one another and storage and retrieval units, operated in an automated manner, for conveying the articles to and from the storage locations. The storage region can alternatively comprise mobile storage racks with storage locations arranged next to one another in rack levels located on top of one another and “AGVs” or “AMRs,” operated in an automated manner, for transporting the storage racks with the articles stored therein. The loading station enables the loading of the at least one loading aid with the articles, for example if the articles are stored in the storage region without the loading aids. Also a reloading from a first loading aid into another loading aid can be done at the loading station. The first loading aid can form a storage loading aid.

In accordance with one possible embodiment, different loading aids are used in the distributor system. The loading aids that are provisioned at the loading station from the provisioning system are configured as first loading aids, preferably containers, and the loading aids that are provisioned at the loading station downstream of the provisioning system and are conveyed in the distributor device, buffer device and in the target system—in the conveying sections downstream of the loading station—are configured as other loading aids. Particularly preferably, hanging bags or transport carriers for hooking in the hanging bags, coat hangers or suchlike are used as other loading aids. Therefore, it can in particular be provided that the articles are reloaded from the containers into hanging bags at the loading station.

It can further be provided that the article store and/or the storage region is connected to the loading station via a conveying system. Here, the conveying system can be configured as an overhead conveying system or as a conveying system that is distinct from the overhead conveying system, as described previously. Particularly preferably, the conveying system between the storage region and the loading station is configured as a roller conveying system or as a belt conveying system.

It is advantageous if the buffer region has at least one buffer line arranged between the buffer infeed line and the buffer outfeed line and at least one buffer return line arranged between the buffer outfeed line and the buffer infeed line. Preferably, the first buffer device is therefore configured as a dynamic buffer. Here, the articles can be conveyed with the loading aids along the buffer line, which results in mobile buffer locations. The articles can also be conveyed with the loading aids along the buffer return line from one end of the buffer line back to a start of the buffer line. This results in a dynamic buffer. The buffer line and the buffer return line preferably form a buffer circuit, in which the articles can be conveyed in a direction of circulation.

Preferably, is provided that the target system has a workstation with a workstation infeed line, wherein the first distributor device is connected, in terms of conveyance, to the workstation infeed line and is configured to convey the loading aids from the distributor line to the workstation infeed line. To this end, the second distributor outfeed line can be connected to the workstation infeed line, for example.

At the workstation, the orders can be processed. To this end, the workstation is configured, for example, as a picking station, as a packing station or as a shipping station. Also multiple workstations operating in parallel can be provided in order to process multiple orders at the same time and thus operate the picking system with particularly high throughput. Also multiple workstations, for example a packing station and a shipping station following the packing station, can be provided in succession in a process direction. If the workstation comprises a picking station, articles included in the orders are picked there. Here, the articles are removed from the loading aids and placed into order loading aids in accordance with the orders.

It is favorable if the target system comprises a sorting device (operated in an automated manner) with a sorting infeed line, wherein the first distributor device is connected, in terms of conveyance, to the sorting infeed line and is configured to convey the loading aids from the distributor line to the sorting infeed line. To this end, it is favorable if the distributor system comprises another, in particular fourth, distributor outfeed line, via which the distributor line is connected, in terms of conveyance, to the sorting infeed line.

Preferably, the sorting device comprises a first sorting stage and optionally a second sorting stage. Furthermore, one or multiple other sorting stages can be provided. For example, the sorting device comprises a matrix sorter, which has one or multiple sorting stages arranged in succession.

It can further be provided that the sorting device has a presorting buffer. For example, the presorting buffer can be configured as a buffer line arranged upstream of the first sorting stage. The buffer line can be provided as a buffer line that is arranged between the distributor line and the first sorting stage in a process direction, or as a subsection of the distributor line. Particularly preferably, the presorting buffer is configured as a buffer circuit. Advantageously, the presorting buffer is arranged between the buffer infeed line and the first sorting stage.

It is further favorable if the first distributor device is connected, in terms of conveyance, to a return line, which is configured to convey the loading aids back into the provisioning system.

The return line ensures, for example, that loading aids without articles can be conveyed back into the provisioning system. This is advantageous in particular for conveying empty loading aids from the buffer device into the provisioning system because they have already been unloaded, for example.

It is also possible that loading aids with articles are conveyed back into the provisioning system. This can be advantageous in particular whenever an order structure changes and individual articles, or entire orders, are no longer required at the workstation. This may be the case, for example, if an order is canceled after the articles assigned to the order were retrieved but before the order has been processed at the workstation.

Furthermore, the return line enables a conveyance of the articles from a first provisioning region into a second provisioning region via the distributor device and the return line. For example, articles can be rearranged from a first storage region to another storage region.

Preferably, it is provided that the distributor line is configured as a circulation circuit, wherein the loading aids can be conveyed in the circulation circuit in a direction of circulation. This enables articles with the loading aids to be discharged, for example, from the (first) buffer device and to be forwarded again to the (first) buffer device, or optionally to another (other) buffer device, while essentially bypassing the target system. Here, the articles with the loading aids are conveyed essentially for a short term, namely between the target system and the first distributor infeed line and/or the (first) buffer device, in particular opposite the process direction but in a direction of circulation. It is in particular provided that all loading aids are conveyed in the same direction of circulation inside the distributor line.

The circulation circuit can be configured by a continuous, endlessly revolving conveying system.

Alternatively, the circulation circuit can also be configured by multiple conveying system sections adjoining one another. For example, the circulation circuit comprises a first conveying system section with a first and second end, a second conveying system section with a first and second end, wherein the first end of the second conveying system section adjoins the second end of the first conveying system section, a third conveying system section with a first and second end, wherein the first end of the third conveying system section adjoins the second end of the second conveying system section, and a fourth conveying system section with a first and second end, wherein the first end of the fourth conveying system section adjoins the second end of the third conveying system section and the second end of the fourth conveying system section adjoins the first end of the first conveying system section. Here, it can in particular be provided that the first and third conveying system sections are arranged at a different height levels and the second and fourth conveying system sections each bridge the different height levels. The second and fourth conveying system sections can be configured as lifting and/or lowering devices and/or as upward and/or downward sloping conveyors.

It is further favorable if a connection, in terms of conveyance, of the first distributor device to the buffer infeed line is arranged downstream of the first distributor infeed line and upstream of the second distributor infeed line in the direction of circulation. This results in a particularly short residence time of the articles on the distributor line, as the articles can be supplied to the (first) buffer device already early on along the distributor line. The picking system can thus be operated particularly efficiently.

Furthermore, it is advantageous if a connection, in terms of conveyance, of the first distributor device to the target system is arranged downstream of the second distributor infeed line and upstream of the first distributor infeed line in the direction of circulation. This, too, results a particularly short residence time of the articles on the distributor line, as the articles can be supplied to the target system early on along the distributor line. The picking system can thus be operated particularly efficiently.

Preferably, the distributor system comprises another buffer device (operated in an automated manner), which has a buffer infeed line and a buffer outfeed line and at least one buffer region arranged between same, another distributor device (operated in an automated manner), which has a first distributor infeed line connected, in terms of conveyance, to the provisioning system, a distributor line and a second distributor infeed line connected to the buffer outfeed line of the other buffer device, wherein the other distributor device is connected, in terms of conveyance, to the buffer infeed line of the first buffer device and is configured to convey loading aids from the distributor line to the first buffer device, and wherein each distributor device is additionally connected, in terms of conveyance, to the buffer infeed line of the other buffer device and is configured to convey loading aids from the respective distributor line to the other buffer device. This further increases the flexibility of the distributor system.

The other distributor device is preferably configured analogous to the first distributor device and can also have the features described in relation to the first distributor device.

In particular, the other distributor device can comprise a distributor line, along which the loading aids can be conveyed, and a first distributor infeed line, wherein the first distributor infeed line is connected, in terms of conveyance, to the provisioning system and is configured to convey the loading aids from the provisioning system to the distributor line.

The other distributor device is preferably configured analogous to the first buffer device and can also have the features described in relation to the first buffer device.

In particular, the buffer region of the other buffer device can have at least one buffer line arranged between the buffer infeed line and the buffer outfeed line and at least one buffer return line arranged between the buffer outfeed line and the buffer infeed line, such as this is shown in FIG. 4, for example. The other buffer device enables a buffering capacity of the distributor system to be increased. Furthermore, multiple other buffer devices can be provided in the same manner.

The other distributor device is preferably connected, in terms of conveyance, to the buffer infeed line of the other buffer device and is adapted to convey the loading aids from the distributor line to the other buffer device. To this end, the distributor system can have another, in particular third, distributor outfeed line, which connects, in terms of conveyance, the distributor lines and the buffer infeed line of the other buffer device.

It is favorable if the other distributor device is connected, in terms of conveyance, to the buffer infeed line of the first buffer device via the first distributor outfeed line and to the buffer infeed line of the other buffer device via the third distributor outfeed line.

The other distributor device can also be connected, in terms of conveyance, to the target system and be adapted to convey the loading aids from the distributor line to the target system. Here, it is favorable if the other distributor device is connected, in terms of conveyance, to the target system via the second distributor outfeed line and/or the other, in particular fourth, distributor outfeed line.

Particularly preferably, it is provided that the distributor devices are connected to the workstation via the second distributor outfeed line and to the sorting device via the fourth distributor outfeed line.

Furthermore, the other distributor device can be connected, in terms of conveyance, to the return line.

Further, the other distributor device can be configured as a circulation circuit, wherein the loading aids can be conveyed in the circulation circuit in the direction of circulation.

In the other distributor device, just like in the first distributor device, it can be provided that, while making use of the above-mentioned advantages, the connection, in terms of conveyance, of the other distributor device to the buffer infeed line is arranged downstream of the first distributor infeed line and upstream of the second distributor infeed line in the direction of circulation and/or that a connection, in terms of conveyance, of the other distributor device to the target system is arranged downstream of the second distributor infeed line and upstream of the first distributor infeed line in the direction of circulation.

The other distributor device enables a flexibility of the distributor system to be increased. Furthermore, multiple other distributor devices can be provided in an analogous manner.

Preferably, it is provided that any and all distributor lines are each connected to the buffer infeed lines of all buffer devices. This enables loading aids to be conveyed into any buffer device, independent of which distributor line was selected.

It is also possible, for example, to discharge loading aids from the first buffer device and forward them to the other buffer device via the first distributor line in order to empty the first buffer device completely, for example for maintenance purposes.

From the second buffer device, the articles can subsequently be conveyed to the target system via the second distributor line, or be conveyed back again into the first buffer device.

Optionally, the second distributor infeed lines of any and all distributor lines can be connected, in terms of conveyance, to the buffer outfeed lines of all buffer devices, whereby a flexibility of the distributor system is additionally increased.

Also disclosed is a method for provisioning at least one article and/or articles included in an order, wherein the method comprises the following steps:
i) acquiring orders and determining at least one article that is assigned to an order of the orders by means of an electronic order management system;
ii) provisioning the at least one article with at least one loading aid in a provisioning system;
iii) discharging the at least one loading aid from the provisioning system and forwarding the at least one loading aid into a first distributor device via a first distributor infeed line of the first distributor device;
iv) conveying the at least one loading aid along a distributor line of the first distributor device and transferring the at least one loading aid from the distributor line onto a buffer infeed line of a first buffer device, in particular via a first distributor outfeed line;
v) forwarding the at least one loading aid into a buffer region of the first buffer device and temporarily storing the at least one loading aid in the buffer region;
vi) discharging the at least one loading aid from the buffer region via a buffer outfeed line of the first buffer device and transferring the at least one loading aid from the buffer outfeed line onto the distributor line of the first distributor device via a second distributor infeed line of the first distributor device;
vii) conveying the at least one loading aid along the distributor line and discharging the at least one loading aid from the distributor line;
viii) forwarding the at least one loading aid to the target system, preferably via a second distributor outfeed line, which connects, in terms of conveyance, the distributor line and the target system, in particular for processing the order.

One advantage achieved with the method is in particular that the articles can be conveyed both to the buffer device and to the target system via the jointly used distributor line, whereby the articles can be distributed particularly simply and flexibly in the picking system, in particular in accordance with a conveying process specified by the order.

Here, the distribution system is preferably operated in an automated manner.

The conveying process is usually specified by the order. For example, the order can comprise multiple articles, which are first temporarily stored in the buffer device and must subsequently be conveyed into the target system.

In the step i), at least one order, and, as a rule, a plurality of orders, are electronically acquired and the articles that are assigned to the respective order are determined. This is done by means of an electronic order management system.

The provisioning of the articles with the at least one loading aid in the step ii) can comprise, for example, a retrieval of the articles from a storage region with the at least one (first) loading aid. Here, the storage region can be provisioned by an article store, for example. In addition, the articles can be provisioned at the loading station with the at least one first loading aid. At the loading station, the articles can be reloaded from the first loading aid into the at least one (second) loading aid.

To ensure a particularly high flexibility and enable an access to individual articles of the order, it may be advantageous if a number of articles per loading aid is exactly one.

It is advantageous if the transferring of the at least one loading aid in the steps iv) and vi) and/or the discharging in the step vii) are each done via a discharge line or a switch.

It is favorable if the steps iv) to vi) are repeated with the same at least one loading aid in a second cycle before carrying out the step viii). This enables loading aids to be discharged from the buffer device and optionally be conveyed back into the buffer device again. This is advantageous in particular for a maintenance of the buffer device and/or of individual buffer lines of the buffer device. Here, the loading aids can be discharged from a first buffer line of the first buffer device, conveyed back to the buffer device via the distributor device and forwarded, for example, onto a second buffer line of the first buffer device. The first buffer line of the first buffer device can thus be emptied, for example for maintenance work.

Furthermore, it is advantageous if the steps iv) to vi), in the second cycle, are carried out for another buffer device instead of the first buffer device. This enables loading aids to be relocated from the first buffer device into the other buffer device. This can be advantageous in particular for maintenance work on the first buffer device.

It is further favorable if, in the second cycle, the at least one loading aid is transferred, in the step vi), onto a distributor line of the other distributor device via a second distributor infeed line of another distributor device. This enables the loading aids to be moved flexibly between the distributor devices and the buffer devices. The at least one loading aid can also be conveyed from the other buffer device to the first buffer device via the other distributor device, whereby all buffer devices can be used with any and all distributor devices in a fully flexible manner.

It can further be provided that, in the step i), at least one article that is assigned to another order of the orders is determined, wherein the steps ii), iii), vii) and viii) are carried out for the at least one article assigned to the second order while omitting the steps iv), v) and vi). This enables the buffer device to be bypassed, and thus a bypass to be realized, in a simple manner. Individual articles and/or orders which need not be temporarily stored in the buffer device can thus be conducted past the buffer device and conveyed directly to the target system via the distributor line.

The other object is achieved with a method of the kind mentioned in the beginning, wherein the method comprises the following steps:
i) acquiring an order and determining a first order part, which comprises at least one article assigned to the order, which article is provisioned in a first provisioning region of a provisioning system of the picking system, and determining a second order part, which comprises at least one article assigned to the order, which article is provisioned in a second provisioning region of the provisioning system of the picking system, by means of an electronic order management system;
ii) provisioning the at least one article of the first order part with at least one first loading aid in the provisioning system and provisioning the at least one article of the second order part with at least one second loading aid in the provisioning system;
iii) forwarding the at least one first loading aid into a buffer device, in particular into the first buffer device, and temporarily storing the at least one first loading aid in the buffer device, in particular in the buffer region of the buffer device;
iv) determining a conveying duration for the at least one article of the second order part from the second provisioning region to a merging section, in which the at least one first loading aid and the at least one second loading aid are merged, by means of a control device;
v) releasing the discharge of the at least one first loading aid with the at least one article of the first order part from the buffer device by the control device on the basis of the determined conveying duration, so that the at least one first loading aid and the at least one second loading aid are merged for the order in the merging section;
vi) conveying the at least one second loading aid with the at least one article of the second order part from the second provisioning region to the merging section while bypassing the buffer device;
vii) discharging the at least one first loading aid from the buffer device and conveying the at least one first loading aid from the buffer device to the merging section;
viii) conveying the at least one first loading aid and the at least one second loading aid of the order from the merging section, preferably via a second distributor outfeed line, which connects, in terms of conveyance, the distributor line and the target system, to the workstation.

One advantage achieved with the method is in particular that the second order part, which comprises, for example, articles that can only be provisioned at a later point in time because, for example, a production of the articles has not yet been finished, can be merged with the first order part in the merging section while bypassing the buffer device. This enables an order to be initiated, for example, before any and all articles assigned to the order are available, whereby a particularly efficient operation of the picking system can be realized.

The distribution system is preferably operated in an automated manner.

Here, the merging section corresponds essentially to the conveying section in the distributor system in which the at least one first loading aid and the at least one second loading aid are merged (in terms of material flow). The merging section is preferably a conveying section, in particular a section of the distributor line, which adjoins the second distributor infeed line. It is advantageous here that a separate bypass conveyor line is not required as the articles of the second order part can be conducted along the distributor line essentially past the buffer device.

Furthermore, the first provisioning region can comprise a storage region, for example. The second provisioning region can comprise a different storage region and/or a production region.

A chronological sequence in which the steps v) and vi) are executed is discretionary. For example, the steps v) and vi) can be carried out so as to overlap in time or in parallel and/or simultaneously. It is also conceivable that step v) is carried out first and step vi) subsequently, or step vi) first and step v) subsequently.

Here, the buffer device can be the first buffer device or the other buffer device, as these have been described above.

Preferably, the conveying duration comprises the duration and/or time that is required for conveying the article(s) of the second order part from the second provisioning region to the merging section. The conveying duration therefore preferably comprises a conveying time. In addition, the conveying duration can comprise the duration and/or time that is required for loading the at least one second loading aid with the article or articles of the second order part at a loading station, for example. In this case, the conveying duration comprises a loading time and the conveying time.

Here, the term “while bypassing the buffer device” is intended to mean that the at least one loading aid is conducted past the buffer device in the sense of a material flow.

To this end, the distribution system can comprise a bypass conveyor line, which connects, in terms of conveyance, the provisioning system and the target system. The bypass conveyor line preferably comprises the distributor line and/or the bypass conveyor line is preferably provisioned by the distributor line. In the step vi), the at least one second loading aid is preferably conveyed along the bypass conveyor line.

The conveying in the step viii) can comprise a sorting of the articles and/or of the loading aids in a sorting device. Alternatively, the conveying in the step viii) can be done while bypassing the sorting device.

Here, the term “while bypassing the sorting device” is intended to mean that the at least one loading aid is conducted past the sorting device in the sense of a material flow. To this end, the distribution system can comprise a sorter bypass conveyor line, which connects, in terms of conveyance, a conveying section arranged upstream of the sorting device, for example a conveying section of the provisioning system, of the buffer device and/or of the distributor device, to a workstation (arranged downstream of the sorting device in a process direction). In the step viii), the at least one second loading aid is preferably conveyed along the bypass conveyor line.

To ensure a particularly high flexibility and enable an access to individual articles of the order, it may be advantageous if a number of articles per second loading aid is exactly one.

Preferably, it is provided that the forwarding in step iii) comprises the following steps:
discharging the at least one first loading aid from the provisioning system and forwarding the at least one first loading aid into a first distributor device via a first distributor infeed line of a first distributor device;
conveying the at least one first loading aid along a distributor line of the first distributor device and transferring the at least one loading aid from the distributor line onto a buffer infeed line of the buffer device via a first distributor outfeed line.

It is favorable if the first provisioning region comprises a storage region and a loading station and the following steps are carried out in the step ii) for provisioning the at least one article of the first order part with at least one first loading aid:
retrieving the at least one article of the first order part from the storage region and
loading the at least one first loading aid with the at least one article of the first order part at the loading station.

As described above, the articles can thus be reloaded, for example from loading aids in which the articles are stored into the loading aid for conveying by the distributor device. The storage region can be provisioned by an article store, for example.

Furthermore, it is advantageous if the second provisioning region comprises a loading station and comprises the following step for provisioning the at least one article of the second order part with at least one second loading aid:
loading the at least one second loading aid with the at least one article of the second order part at the loading station.

Here, it can be provided that the conveying duration additionally comprises the duration and/or time that is required for loading the at least one second loading aid at the loading station with the at least one article of the second order part. The conveying duration thus preferably comprises at least the conveying time and the loading time.

The other object is further achieved with a method of the kind mentioned in the beginning, wherein the method comprises the following steps:
i) acquiring an order, which is assigned at least one article, by an electronic order management system;
ii) classifying the order in accordance with a classification criterion as a “sorting order” if a sorting of the at least one loading aid upstream of a workstation in the target system is required, or as a “non-sorting order” if the sorting of the at least one loading aid upstream of the workstation is not required, by the electronic order management system;
iii) provisioning the at least one article with at least one loading aid in a provisioning system, in particular comprising a retrieval of the at least one article assigned to the order from a provisioning region of a provisioning system;
iv) forwarding the at least one loading aid into a buffer device, in particular into the first buffer device, and temporarily storing the at least one loading aid in the buffer device, in particular in the buffer region of the buffer device;
v) discharging the at least one loading aid from the buffer device and forwarding the at least one loading aid to the target system;
vi) conveying the at least one article to the workstation by means of a conveying system comprising:
   forwarding the at least one loading aid into a sorting device if the at least one loading aid is assigned to a sorting order,
   sorting the at least one loading aid by the sorting device,
   forwarding the at least one loading aid from the sorting device to the workstation;
or
   forwarding the at least one loading aid from the buffer device to the workstation while bypassing the sorting device if the at least one article is assigned to a non-sorting order.

One advantage achieved with the method is in particular that articles pertaining to non-sorting orders, i.e. to orders whose articles and/or loading aids need not be sorted, are not supplied to the sorting device but conducted past the sorting device, in particular by a (additional) conveying system, and can therefore be provisioned at the workstation particularly quickly. In other words, the provisioning region and the workstation are connected, in terms of conveyance, in order to convey the articles and/or the loading aids directly from the provisioning region to the workstation. This enables the picking system to be operated in a highly flexible and efficient manner. Here, the provisioning region preferably comprises a storage region and/or an article store. The (additional) conveying system can be provisioned by the distributor line, for example.

The distribution system is preferably operated in an automated manner. The conveying, forwarding and/or discharging in the steps iv), v) and vi) can be done by means of a conveying system, in particular a conveying system as described above.

It is favorable if the forwarding in step iv) comprises the following steps:
discharging the at least one first loading aid from the provisioning system and forwarding the at least one first loading aid into a first distributor device via a first distributor infeed line of a first distributor device;
conveying the at least one first loading aid along a distributor line of the first distributor device and transferring the at least one loading aid from the distributor line onto a buffer infeed line of the buffer device via a first distributor outfeed line.

The classification criterion can be selected from a list comprising an order size, an order structure, a sorting capacity at the workstation and suchlike. The classification criterion can also comprise multiple of these criteria.

Here, the order size describes, for example, which number of articles the order comprises. An order that comprises merely a single article need not be sorted and is therefore preferably classified as a “non-sorting order.” For an order that comprises more than one article, a sorting upstream of the workstation may optionally be required, in particular if the order comprises multiple articles of different types of article. Such an order can therefore be classified as a “sorting order.”

The order structure describes, for example, how many types of article the order comprises. If the order comprises multiple articles of the same type of article, the articles often need not be sorted upstream of the workstation. The order can therefore be classified as a “non-sorting order.” However, if the order comprises a plurality of articles of different types of article, a sorting upstream of the workstation may optionally be required, so that the order is classified as a “sorting order.” This is the case in particular whenever shipping containers are to be loaded with the articles and the articles must be provisioned at the workstation in a sequence defined by a packing order.

Further, the sorting capacity at the workstation can specify, for example, a threshold value as to which number of articles of different types of article of an order can be sorted immediately at the workstation. If the number of the articles is below this threshold value, the order can be classified as a “non-sorting order.” If the number of the articles is at or above the threshold value, the order can be classified as a “sorting order.”

The steps i) and iii) to vi) are preferably carried out in the specified sequence.

The classifying in the step ii) is expediently done before the step vii). The step ii) can be carried out before the step vii) at any point in time in the method. Particularly preferably, step ii) is carried out between the steps i) and iii).

To ensure a particularly high flexibility and enable an access to each individual article of an order, it may be advantageous if a number of articles per loading aid is exactly one.

Furthermore, it is advantageous if the order is classified as a “sorting order” if the number of the articles, in particular of different types of article, assigned to the order is greater than one and the order is classified as a “non-sorting order” if the number of the articles assigned to the order is exactly one. Thus, orders which are each assigned exactly one article, so-called single-item orders, can be conveyed past the sorting device, in particular by a (additional) conveying system, whereby an increased article throughput is achieved and therefore also the picking system can be operated particularly efficiently. The (additional) conveying system can be provisioned by the distributor line, for example. Furthermore, sorting capacities can be saved as the single-item orders do not occupy any space in the sorting device.

It should be mentioned that the conveyance, in particular the discharge and/or forwarding, of the articles and/or of the loading aids can be done by means of a conveying system. To this end and as described above, the conveying system can be configured in particular as an overhead conveying system or as a conveying system distinct from the overhead conveying system, for example as a ground-based conveying system.

Accordingly, it can advantageously be provided that the conveyor lines, in particular the first distributor infeed line, the distributor line, the second distributor infeed line, the distributor outfeed lines, the buffer infeed line, the buffer lines, the buffer return line, the buffer outfeed line, the sorting infeed line, the workstation infeed line and/or the return line, are each provisioned by a conveying system. As described previously, the conveying system is in particular configured as an overhead conveying system or as a conveying system that is different from the overhead conveying system.

A connection, in terms of conveyance, between two conveyor lines can in particular be formed in that the conveyor lines adjoin each other or are interconnected via a switch section.

### BRIEF DESCRIPTION OF THE DRAWINGS

Other features, advantages and effects of the invention may result from the embodiment represented below. The drawings, to which reference is made there, show:

FIG. 1 a first embodiment of a distributor system;

FIGS. 2a, 2b, 2c different embodiments of a provisioning system of the distributor system;

FIG. 3 a target system of the distributor system;

FIG. 4 a buffer device of the distributor system;

FIG. 5 another embodiment of the distributor system;

FIG. 6 a first method for provisioning articles in a target system;

FIG. 7 a second method for provisioning articles in a target system;

FIG. 8 a third method for provisioning articles in a target system.

### DETAILED DESCRIPTION OF EXEMPLARY EMBODIMENTS

First of all, it is to be noted that, in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure, and, in case of a change of position, are to be analogously transferred to the new position.

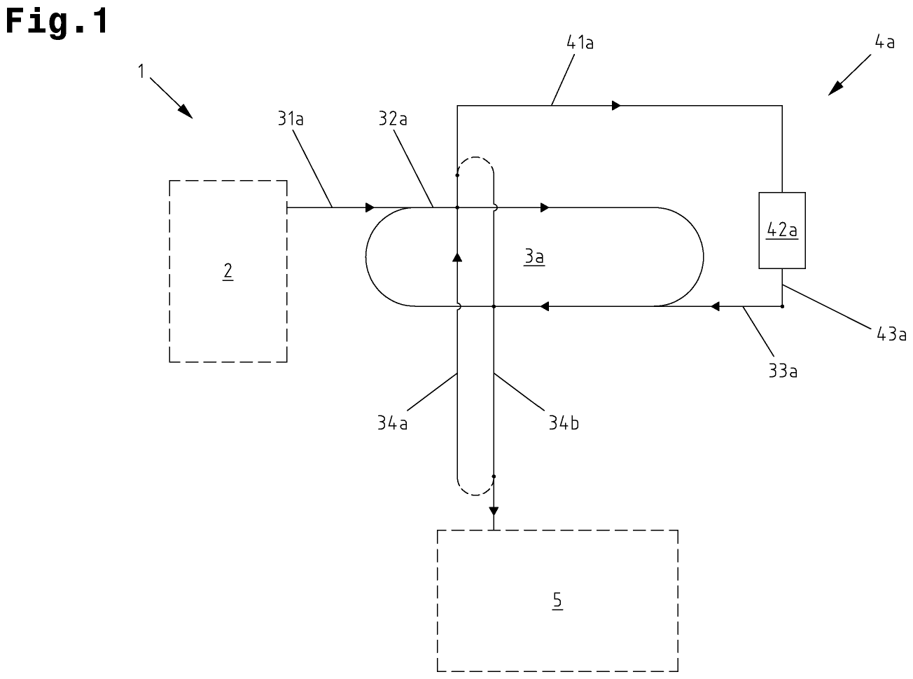

FIG. 1 shows a first embodiment of a distributor system 1. The distributor system 1 represented comprises a provisioning system 2, a first distributor device 3a, a first buffer device 4a and a target system 5. The distributor device 3a is connected, in terms of conveyance, to the provisioning system 2, to the first buffer device 4a and to the target system 5.

The distributor device 3a comprises a distributor line 32a as well as a first distributor infeed line 31a, which forms a connection, in terms of conveyance, between the provisioning system 2 and the distributor line 32a. Via the first distributor infeed line 31a, articles can be conveyed from the provisioning system 2 to the distributor line 32a. Furthermore, the distributor device 3a comprises a second distributor infeed line 33a, which forms a connection, in terms of conveyance, between the buffer device 4a and the distributor line 32a.

In the embodiment represented, the distributor line 32a is configured as a revolving conveyor line and/or circulation circuit. The circulation circuit can in particular be formed by an endlessly revolving conveying system. Alternatively, the distributor line 32a can be configured in particular as a non-revolving conveyor line with a first and second end.

Further, the distributor line 32a can have a first, second, third and fourth conveying system section, wherein the first conveying system section forms a forward conveyor line and the third conveying system section forms a return conveyor line. Further, it can be provided that the second conveying system section forms a first reverse section between the first and third conveying system section and the fourth conveying system section forms a second reverse section between the third and the first conveying system section. The second and/or fourth conveying system can be configured structurally identical with the first and second conveying system. The second or fourth conveying system can also each be configured as a lifting and/or lowering device and/or as an upward and/or downward sloping conveyor, wherein the forward and the return conveyor lines are arranged above each other and/or at different height levels.

To provision a connection, in terms of conveyance, between the first distributor device 3a and the first buffer device 4a, the distributor system 1, in the example shown, comprises a first distributor outfeed line 34a leading towards the first buffer device 4a, which first distributor outfeed line 34a is connected to the distributor line 32a.

To provision a connection, in terms of conveyance, between the first distributor device 3a and the target system 5, the distributor system 1, in the example shown, comprises a second distributor outfeed line 34b leading towards the target system 5, which second distributor outfeed line 34b is connected to the distributor line 32a.

In a preferred embodiment, the connection, in terms of conveyance, between the first distributor device 3a as well as the first buffer device 4a and the target system 5 is configured as a revolving conveyor line and/or as circulation circuit. To this end, optional reverse sections can be provided, which connect the first distributor outfeed line 34a and the second distributor outfeed line 34b and which are represented in dashed lines in FIG. 1. Here, the reverse sections are each arranged such that they connect a second end of the first distributor outfeed line 34a to a first end of the second distributor outfeed line 34b and/or a second end of the second distributor outfeed line 34b to the first end of the first distributor outfeed line 34a.

The buffer device 4a comprises a buffer infeed line 41a, a buffer region 42a and a buffer outfeed line 43a. Here, the connection, in terms of conveyance, runs from the distributor line 32a to the buffer infeed line 41a between the distributor device 3a and the first buffer device 4a. To this end, the buffer infeed line 41a can adjoin the distributor line 32a immediately, or be connected to same via a connection section.

The buffer region 42a is arranged so as to adjoin the buffer infeed line 41a and configured for temporarily storing loading aids. Advantageously, the buffer region 42a is configured as described below in relation to FIG. 4.

The buffer outfeed line 43a is arranged so as to adjoin the buffer region 42a and lead away from it. Here, the connection, in terms of conveyance, runs from the buffer outfeed line 43a to the distributor line 32a between the first buffer device 4a and the distributor device 3a. To this end, the buffer outfeed line 41a can adjoin the distributor line 32a immediately, or be connected to same via a connection section.

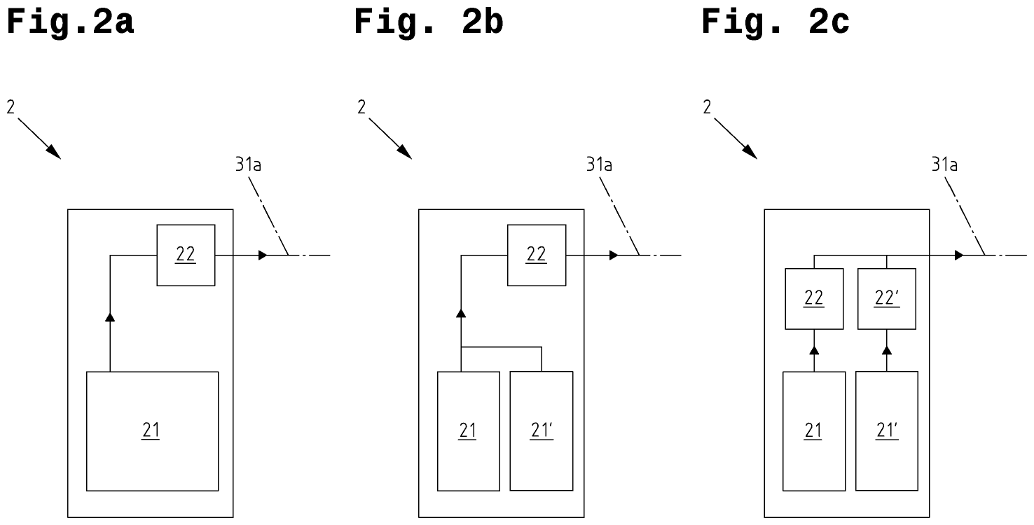

FIG. 2a shows a first embodiment of the provisioning system 2. In the variant shown, the provisioning system 2 comprises a first provisioning region with a storage region 21 and/or article store and a loading station 22. The storage region 21 and the loading station 22 are connected in terms of conveyance. At the loading station 22, loading aids can be loaded with articles which have been provisioned at same.

Further, the loading station 22 is connected, in terms of conveyance, to the first distributor infeed line 31a and, via same, to the distributor line 32a, so that loaded loading aids can be conveyed from the loading station 22 to the distributor line 32a. To this end, the loading station 22 can adjoin the distributor line infeed line 31a immediately, or be connected to same via a connection section.

In a second embodiment shown in FIG. 2b, the provisioning system 2 comprises the first provisioning region with the storage region 21 and a second provisioning region, which has another storage region 21′. Here, the storage regions 21, 21′ are connected, in terms of conveyance, to the loading station 22. Thus, the provisioning system 2 comprises a loading station 22 that is assigned to both provisioning regions.

In a third embodiment shown in FIG. 2c, the first provisioning region comprises the storage region 21 and the loading station 22. The second provisioning region comprises the other storage region 21′ and another loading station 22′. Thus, the provisioning system 2 comprises a loading station 22, 22′ for each of the provisioning regions.

Furthermore, the first and/or second provisioning region can comprise a production region, not represented in FIG. 2a to FIG. 2c, which is provided in addition to the storage region 21, 21′ or instead of the storage region 21, 21′.

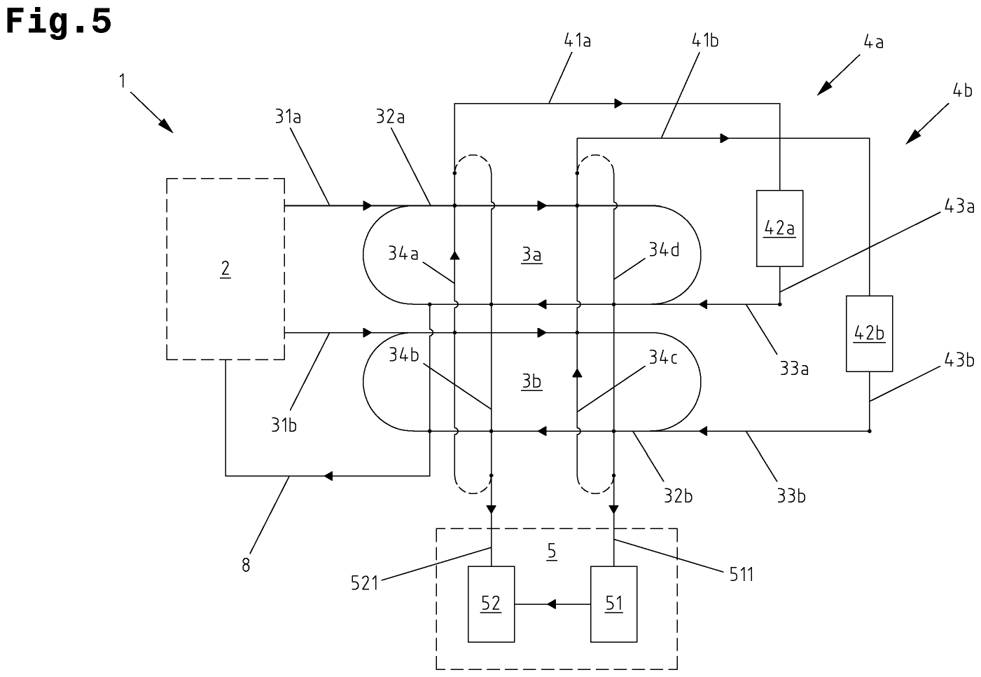

If multiple distributor lines 32a, 32b are provided, as this is represented below in FIG. 5, for example, the loading station 22 and/or the loading station 22′ can each be connected, in terms of conveyance, to (exactly) one of the distributor lines 32a, 32b, or to both distributor lines 32a, 32b.

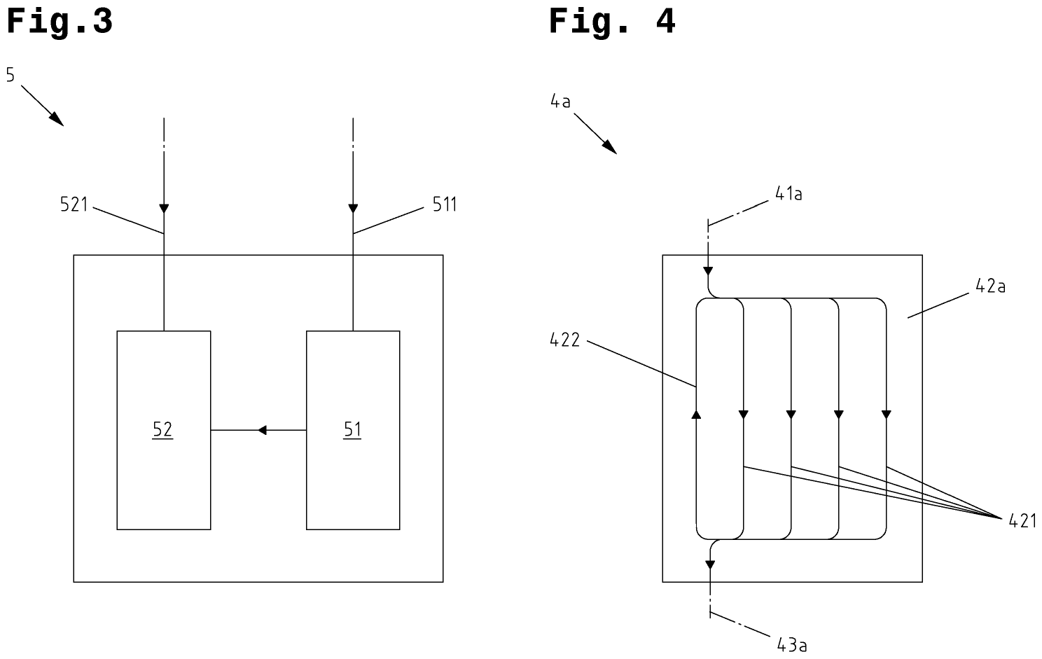

FIG. 3 shows a preferred embodiment of a target system 5, comprising a sorting device 51 as well as a workstation 52. As already described in relation to FIG. 1, the distributor device 3a is connected, in terms of conveyance, to the target system 5.

Furthermore, preferably inside the target system 5, a connection, in terms of conveyance, is provided between the sorting device 51 and the workstation 52.

Further, the target system 5 can have any number of workstations 52 and/or sorting devices 51. Here, “any number” may also be 0 if no sorting device 51 or no workstation 52 is provided in an embodiment, for example.

The workstation 52 comprises preferably at least one picking device and/or packing device.

FIG. 4 shows an embodiment of a first buffer device 4a. Here, the buffer region 42a comprises multiple buffer lines 421 arranged between, and connected to, the buffer infeed line 41a and the buffer outfeed line 43a. In the simplest case that is not represented, the buffer region 42a has exactly one such buffer line 421.

Furthermore, the buffer region 42a comprises at least one buffer return line 422 arranged between the buffer outfeed line 43a and the buffer infeed line 41a. In the example shown, exactly one buffer return line 422 is provided. Alternatively, the buffer region 42a can have a plurality of buffer return conveyor lines 422. The buffer lines 421 and the at least one buffer return line 422 are interconnected, in terms of conveyance, such that the loading aids can be conveyed, essentially via one of the buffer lines 421 and the at least one return line 422, in a circle inside the buffer device 4a, in particular inside the buffer region 42a.

FIG. 5 shows a second embodiment of the distributor system 1. Here, the distributor system 1 is essentially structured like the first embodiment represented in FIG. 1 and comprises another distributor device 3b as well as another buffer device 4b in addition to the first distributor device 3a and to the first buffer device 4a.

The other distributor device 3b is structured in the same manner as the first distributor device 3a and also comprises a first distributor infeed line 31b, a distributor line 32b and a second distributor infeed line 33b.

Also the other buffer device 4b is structured in the same manner as the first buffer device 4a and also comprises a buffer infeed line 41b, a buffer region 42b and a buffer outfeed line 43b. Particularly preferably, the other buffer device 4b is structured such as this is described in relation to FIG. 4.

Both the first distributor device 3a and the other distributor device 3b are connected, in terms of conveyance, to the provisioning system 2 via the respective first distributor infeed line 31a, 31b. The connections, in terms of conveyance, between the distributor devices 3a, 3b and the provisioning system 2 are schematically represented in FIG. 5. The provisioning system 2 can be configured as represented in FIG. 2a to FIG. 2c, wherein the distributor infeed lines 31a, 31b can each be connected, in terms of conveyance, to the loading device 22 and/or to the loading device 22′.

Further, the distributor devices 3a, 3b are each connected to the first buffer device 4a. To this end, in the example shown, the first distributor outfeed line 34a is connected to the distributor lines 32a, 32b on the one hand and to the buffer infeed line 41a of the first buffer device 4a on the other hand.

In the same manner, the first distributor device 3a and the other distributor device 3b are connected, in terms of conveyance, to the other buffer device 4b. To this end, a third distributor outfeed line 34c is connected to the distributor lines 32a, 32b on the one hand and to the buffer infeed line 41b of the other buffer device 4b on the other hand.

What is more, the distributor devices 3a, 3b are connected, in terms of conveyance, to the target system 5. The target system 5 is schematically represented in FIG. 5 and can preferably be configured as described in relation to FIG. 3.

The distributor devices 3a, 3b are each connected to the workstation 52 of the target system 5. To this end, in the example shown, the second distributor outfeed line 34b is connected to the distributor lines 32a, 32b on the one hand and to the buffer infeed line 521 of the workstation 52 on the other hand.

Analogously, the distributor devices 3a, 3b are each connected to the sorting device 51 of the target system 5. To this end, in the example represented, a fourth distributor outfeed line 34d is connected to the distributor lines 32a, 32b on the one hand and to the sorting infeed line 511 of the sorting device 51 on the other hand.

Particularly preferably, the distributor outfeed lines 34a . . . 34d, as already described in relation to FIG. 1, each form a revolving conveyor line in pairs, wherein reverse sections represented in dashed lines are each arranged between two distributor outfeed lines 34a . . . 34d. It is expedient if respectively one outfeed line 34a . . . 34d leading to a buffer device 4a, 4b and one outfeed line 34a . . . 34d leading to the target system 5 are combined in pairs.

Furthermore, the distributor system represented comprises an optional return line 8, which is connected, in terms of conveyance, to the distributor lines 32a, 32b on the one hand and to the provisioning system 2 on the other hand in order to enable a conveyance of loading aids from the distributor device 3a, 3b back to the provisioning system 2.

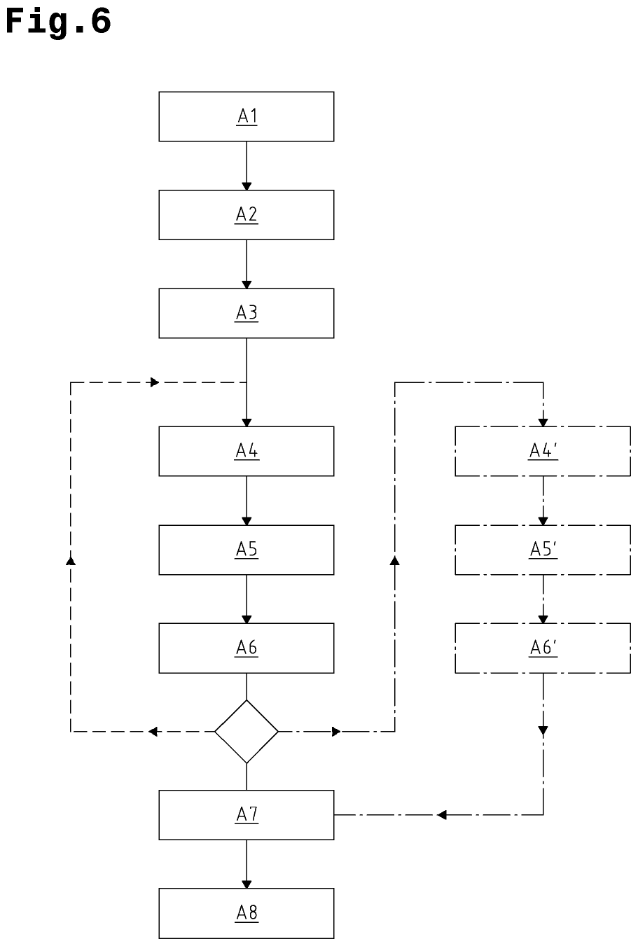

FIG. 6 shows a schematic representation of a first method for provisioning articles included in an order in a target system 5 of a picking system by a distributor system 1 for conveying the articles with loading aids.

Here, in a first step A1, a plurality of orders are acquired by means of an electronic order management system. Here, each of the orders is assigned at least one article. Further, in the first step A1, the at least one article that is assigned to a first order of the acquired orders is determined. The determining of the at least one article can be carried out for other orders, in particular for all acquired orders.

Generally, a distinction can be made between single-item orders, each of which is assigned exactly one article, and multi-item orders, each of which is assigned more than one article. For reasons of better readability, the first method is described below in relation to multi-item orders and therefore for a plurality of articles with multiple loading aids. Evidently, the method can be carried out in the same manner for single-item orders and therefore for exactly one article with exactly one loading aid.

In a second step A2, the articles are provisioned in the provisioning system 2 with the loading aids. A provisioning of the articles in the provisioning system 2 comprises a storage of the articles in the storage region 21 and/or the provisioning of the articles at the loading station 22 and subsequent loading of the loading aids with the articles at the loading station 22.

If the provisioning system 2 comprises a storage region 21, it can be provided, on the one hand, that the articles are stored in the storage region 21. The articles are retrieved from the storage region 21 and provisioned at the loading station 22. At the loading station 22, the loading aids are loaded with the articles. In the storage region 21, the articles can be stored with or without loading aids.

In accordance with one example, the articles with first loading aids and/or storage loading aids are stored in the storage region 21, for example in containers. Here, it can be provided that a plurality of articles of the same type of article are stored in a (joint) first loading aid. The articles are conveyed, with the first loading aids, by a conveying system, for example by means of a container conveying system, from the storage region 21 to the loading station 22 and are provisioned at same. At the loading station 22, the articles assigned to the order are reloaded from the first loading aids into second loading aids, for example hanging bags. Here, it is preferably provided that a second loading aid is respectively loaded with exactly one article. Therefore, it is provided in accordance with this example that different loading aids are used for conveying the articles upstream of the loading station 22, namely the first loading aids, and for conveying the articles away from the loading station 22, namely the second loading aids. Alternatively, the articles can be provisioned already in the (second) loading aids in the storage region 21, so that a reloading is not required.

If the provisioning system 2 comprises a production region, it can be provided that the articles are first provisioned in the production region, for example by producing the articles, forwarded to the loading station 22 or to the other loading station 22′ and provisioned at same. At the loading station 22, 22′, the loading aids can be loaded with the articles. The described variants can also be combined, so that the articles of the order originate partially from the storage region 21 and partially from the production region.

In a third step A3, the loading aids are discharged from the provisioning system 2 and forwarded to the first distributor device 3a. Here, the loading aids are conveyed to the distributor line 32a via the distributor infeed line 31a. A conveyance of the loading aids is preferably done by means of a conveying system, in particular an overhead conveying system.

Subsequently, the loading aids are conveyed, in a fourth step A4, along the distributor line 32a and transferred onto the buffer infeed line 41a of the first buffer device 4a. This is expediently done via the first distributor outfeed line 34a.

In a fifth step A5, the loading aids are conveyed into the buffer region 42a of the first buffer device 4a and temporarily stored in same. In a preferred embodiment, the loading aids are temporarily stored in the buffer region 42a along one of the buffer lines 421.

Further, in a sixth step A6, the loading aids are conveyed from the first buffer device 4a to the distributor line 32a via the buffer outfeed line 43a of the first buffer device 4a. This is done whenever, for example, the loading aids can be conveyed to the sorting device 51 or to the workstation 52 in order to process the order. This may be the case if any and all articles of the order are present in the buffer region 42a or if a sufficient number of articles of the order are present in the buffer region 42a to fill a first shipping cardboard box with them.

The loading aids can also be discharged from the first buffer device 4a and resupplied to same. To this end, essentially the fourth step A4, the fifth step A5 and the sixth step A6 are repeated, as indicated by dashed lines in FIG. 6.

This may be the case, for example, whenever the first buffer device 4a, or individual buffer lines 421 of the first buffer device 4a, must be emptied because maintenance work is carried out on the first buffer device 4a, for example. If a first buffer line 421 of the buffer lines 421 of the first buffer device 4a is to be maintained, for example, the loading aids can be discharged from the first buffer line 421 and resupplied to the first buffer device 4a via the distributor line 32a, wherein the loading aids are directed to another buffer line 421 of the buffer lines 421. This enables the first buffer line 421 to be emptied.

It can further be provided that the loading aids are discharged from the first buffer device 4a and supplied to the other buffer device 4b via the distributor line 32a and temporarily stored in the other buffer device 4b. Subsequently, the loading aids can be discharged from the other buffer device 4b onto the distributor line 32b of the other distributor device 3b, or optionally onto the distributor line 32a of the first distributor device 3a. To this end, essentially the fourth step A4′, the fifth step A5′ and the sixth step A6′ are repeated in modified form, namely for the other buffer device 4b and/or the other distributor device 3b, as indicated in FIG. 6 by dash-dotted lines. This enables the first buffer device 4a to be emptied, for example.

In a seventh step A7, the loading aids are conveyed along the distributor line 32a, 32b and discharged from the distributor line 32a, 32b, in particular via the second distributor outfeed line 34b. Depending on the steps carried out previously, the loading aids are located on the distributor line 32a of the first distributor device 3a or on the distributor line 32b of the second distributor device 3b for carrying out the seventh step A7. The seventh step A7 refers to the corresponding distributor line 32a, 32b.

In an eighth step A8, the loading aids are conveyed to the target system 5.

In the target system 5, the loading aids can be conveyed to the sorting device 51 via the sorting infeed line 511.

The sorting device 51 is used to sort the loading aids of the order in accordance with a sorting specification, which specifies, for example, in which sequence the loading aids are needed at the workstation. After the sorting, the loading aids are conveyed to the workstation 52 at which the order is processed.

Alternatively, the loading aids can be conveyed to the workstation 52 via the workstation infeed line 521 while bypassing the sorting device 51 and provisioned immediately at the workstation 52.

The workstation 52 can be configured as a picking station, at which the articles assigned to the order are removed from the loading aids and shipping containers, for example cardboard boxes, are loaded with these articles.

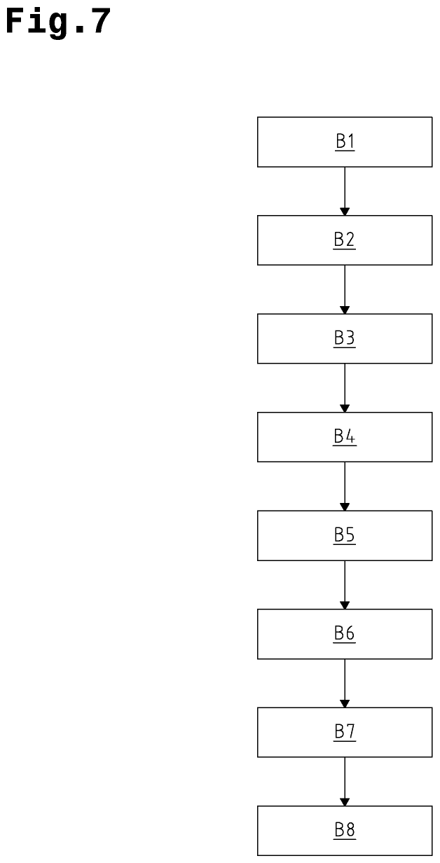

In FIG. 7, a second method for provisioning articles included in an order in a target system 5 of a picking system by a distributor system 1 for conveying the articles with loading aids is schematically represented, wherein the articles of a first order part of the order are temporarily stored in the first buffer device 4a and the articles of a second order part of the order are conducted past the first buffer device 4a.

To this end, an order is acquired by means of the electronic order management system in a first step B1. Furthermore, the first order part as well as the second order part for this order are determined.

The first order part comprises at least one article assigned to the order, which is provisioned in the first provisioning region of the provisioning system 2. The first provisioning region can be configured, for example, as described in relation to FIG. 2b or FIG. 2c, wherein the articles are provisioned and/or stored in the storage region 21.

The second order part comprises at least one article assigned to the order, which is provisioned in the second provisioning region of the provisioning system 2. The second provisioning region can also be configured as described in relation to FIG. 2b or FIG. 2c, wherein the articles are provisioned and/or stored in the other storage region 21′. Alternatively, the at least one article of the second order part can be provisioned in a production region as described above.

For reasons of clarity, the method for the first and second order parts is described below in relation to a plurality of articles, wherein the first order part and/or the second order part may evidently also comprise merely a single article.

In a second step B2, the articles of the first order part are provisioned in the provisioning system 2 with first loading aids. Here, it is preferably provided that one article each is provisioned in one loading aid each. A provisioning of the articles in the provisioning system 2 comprises a provisioning of the articles in the first provisioning region, for example the storage of the articles in the storage region 21. The articles are provisioned at the loading station 22. Further, the loading aids are loaded with the provisioned articles of the first order part at the loading station 22.

Furthermore, the articles of the second order part are provisioned in the provisioning system 2 with the loading aids. The provisioning of the articles in the provisioning system 2 comprises a provisioning of the articles in the second provisioning region, for example the storage of the articles in the storage region 21′ or a production of the articles in the production region. The articles are provisioned at the loading station 22 or at the other loading station 22′, wherein loading aids are loaded with the provisioned articles at the respective loading station 22, 22′.

In a subsequent third step B3, the first loading aids are discharged from the provisioning system 2 and forwarded to the first distributor device 3a. The loading aids are conveyed to the distributor line 32a via the distributor infeed line 31a. Here, the conveyance of the loading aids is done by means of a conveying system, in particular an overhead conveying system.

The first loading aids are then conveyed along the distributor line 32a and transferred onto the buffer infeed line 41a of the first buffer device 4a. This is expediently done via the first distributor outfeed line 34a.

Furthermore, in a fourth step B4, a conveying duration from the second provisioning region to a merging section is determined for the articles of the second order part by means of a control device. Here, the merging section is the conveying section in which the first loading aids and the second loading aids of an order are merged. Preferably, the merging section is a conveying section arranged downstream of the first buffer device 4a in process direction and can be a part of the distributor line 32a, for example. Alternatively, the merging section can be a section of the (second or fourth) distributor outfeed lines 34b, 34d, of the sorting infeed line 511 or of the workstation infeed line 521.

The conveying duration comprises at least a conveying time. Here, the conveying time specifies the period of time that is required to convey the second loading aids from the second provisioning region to the merging section.

In a preferred embodiment, a loading time on the one hand and the conveying time on the other hand are determined, which complement each other to form the conveying duration. Here, the loading time is the period of time that is required to load the second loading aids with the articles at the (other) loading station 22, 22′. Here, the conveying time further specifies the period of time that is required to convey the second loading aids from the loading station 22, 22′ to the merging section.

In a fifth step B5, the discharge of the first loading aids from the first buffer device 4a is released, taking into account the determined conveying duration.

Furthermore, in a sixth step B6, the second loading aids are forwarded to the merging section while bypassing the first buffer device 4a, thereby essentially realizing a bypass line bypassing the first buffer device 4a. Here, the bypass line is essentially provisioned by a section of the distributor line 32a.

In a seventh step B7, the first loading aids are discharged from the first buffer device 4a and forwarded to the merging section, so that the first loading aids are merged with the second loading aids. The sixth step B6 can be executed simultaneously, or so as to overlap in time, with the seventh step B7.

In an eighth step B8, the loading aids are conveyed to the workstation 52.

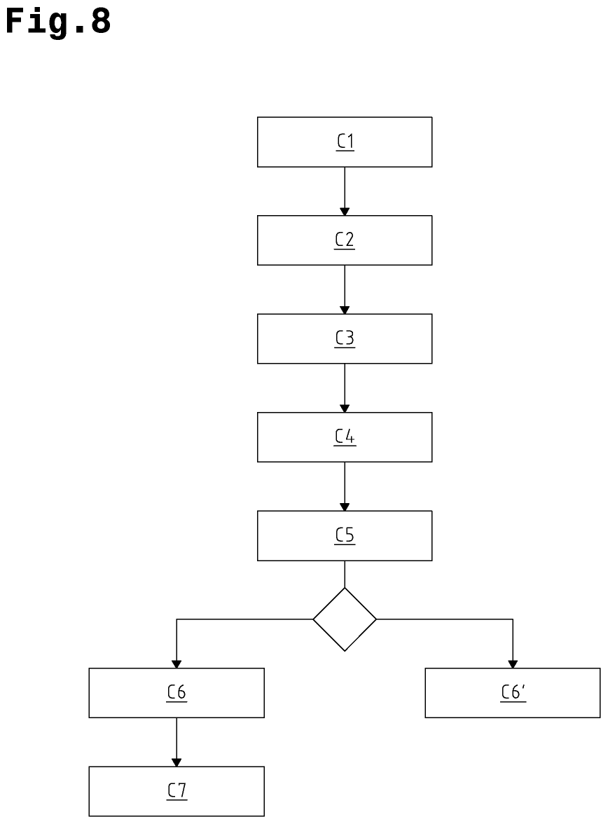

In FIG. 8, a third method for provisioning articles included in an order in a target system 5 of a picking system by a distributor system 1 for conveying the articles with loading aids is schematically represented, wherein the articles of the order are optionally supplied to the sorting device 51, or conducted past same.

Here, in a first step C1, an order is acquired by means of an electronic order management system, wherein at least one article is assigned to the order. Also here, a distinction can be made between single-item orders, each of which is assigned exactly one article, and multi-item orders, each of which is assigned more than one article.

In a second step C2, the order is classified by the electronic order management system. Here, the order is analyzed by the electronic order management system and classified, in accordance with a classification criterion,
as a “sorting order” if a sorting of the at least one article, and/or of the at least one loading aid with which the at least one article of the order is provisioned, is required upstream of the workstation to which the articles are conveyed, or
as a “non-sorting order” if the sorting of the at least one article and/or of the loading aids upstream of the workstation is not required.

The classification criterion can be selected from a group comprising order size, order structure, packing specification or conveyor line capacity utilization.

The order size specifies how many articles the order comprises. If the order comprises merely a single article, for example, i.e. if it is a single-item order, the sorting is obsolete. In this case, the order can be classified as a “non-sorting order.” If the order comprises multiple articles, the order is preferably classified as a “sorting order.”

The order structure specifies, for example, how many types of article the order comprises. If the order comprises multiple articles, but these articles are of the same type of article, the sorting is obsolete. In this case, the order can be classified as a “non-sorting order.” However, if the order comprises multiple articles of different types of article, the order is preferably classified as a “sorting order.”

The packing specification specifies, for example, a sequence and/or order in which the articles must be inserted into a shipping container for shipping in order to load the shipping container. If, for example, a sequence for the loading is specified, a sorting of the articles is required. In this case, the order can be classified as a “sorting order.” However, if no specified loading order is provided, the order can be classified as a “non-sorting order.”

The conveyor line capacity utilization can specify how many loading aids are located along a conveyor line. Here, it may be useful that a single-item order is classified as a “sorting order,” for example, in order to relieve a conveyor line which leads past the sorting device, for example.

In a third step C3, the at least one article assigned to the order is provisioned in the provisioning system 2 with at least one loading aid. Here, the article is preferably discharged from a (first or second) provisioning region, in particular retrieved from the storage region 21, and forwarded to the loading station 22, 22′. At the loading station 22, 22′, a loading aid is loaded with the article. The provisioning in the step C3 can be done as described already in relation to FIG. 6 or FIG. 7.

Subsequently, in a fourth step C4, the at least one loading aid is forwarded into the buffer device 4a and temporarily stored there. If the method is carried out by means of a distributor system 1 which comprises more than one buffer device 4a, 4b, the at least one loading aid is forwarded into one of the buffer devices 4a, 4b and temporarily stored there.

In a fifth step C5, the at least one loading aid is discharged from the buffer device 4a and forwarded to the target system.

If the order was classified as a “sorting order,” the at least one loading aid is forwarded to the sorting device 51 via the sorting infeed line 511 in a sixth step C6 and sorted by means of the sorting device 51 in a seventh step C7.

As used herein, the term “sorting” shall mean that the at least one loading aid is conveyed by the sorting device 51 such that the at least one loading aid leaves the sorting device in a specified sequence.

If the order comprises, for example, multiple loading aids which are forwarded to the sorting device 51 in a sequence that is different from the specified sequence, a resequencing of the loading aids is done inside the sorting device 51.

However, if the loading aids are forwarded to the sorting device 51 already in the specified sequence, the loading aids will be conveyed, during “sorting,” without resequencing by the sorting device 51. An analogous procedure can also be used if the sorting order comprises merely a single loading aid.

After the sorting, the at least one loading aid is forwarded, in an eighth step C8, from the sorting device 51 to the workstation 52.

If the order was classified as a “non-sorting order,” the at least one loading aid is forwarded, in a sixth step C6′, to the workstation 52 via the workstation infeed line 521. Here, the at least one loading aid is conveyed past the sorting device 51.

In the described example, the classifying in the second step C2 is carried out between the first step C1 and the third step C3. However, the classifying can alternatively be carried out at any point in time before the sixth step C6, C6′, in particular before the fifth step C5.

It can be provided for all embodiments described that the conveyor lines, in particular the first distributor infeed line 31a, 31b, the distributor line 32a, 32b, the second distributor infeed line 33a, 33b, the distributor outfeed lines 34a, 34b, 34c, 34d, the buffer infeed line 41a, 41b, the buffer lines 421, the buffer return line 422, the buffer outfeed line 43a, 43b, the sorting infeed line 511, the workstation infeed line 521 and/or the return line 8 are each provisioned by a conveying system.

Furthermore, a connection, in terms of conveyance, between two conveyor lines can be provisioned in that the conveying system of one of the two conveyor lines adjoins the conveying system of the other conveyor line and/or in that the conveying systems are interconnected via switch sections.

Analogously, in the described method, it is preferably provided that a conveyance of the articles and/or of the loading aids is done in an automated manner and/or by means of the conveying system.

Finally, it should also be noted that the scope of protection is determined by the claims. However, the description and the drawings are to be adduced for construing the claims.

In particular, it should also be noted that, in reality, the depicted devices can also comprise more, or also fewer, components than depicted. In some cases, the shown devices and/or their components may not be depicted to scale and/or be enlarged and/or reduced in size.

1. A distributor system for conveying articles with loading aids in a picking system, comprising
a provisioning system for provisioning the articles with loading aids,
a first distributor device for distributing the loading aids which is arranged downstream of the provisioning system,
a first buffer device for temporarily storing the loading aids, which has a buffer infeed line and a buffer outfeed line and at least one buffer region arranged between the buffer infeed line and the buffer outfeed line, and
a target system for processing orders which is arranged downstream of the first distributor device,
wherein the first distributor device
has a distributor line, along which the loading aids can be conveyed,
has a first distributor infeed line, which is connected, in terms of conveyance, to the provisioning system and is configured to convey the loading aids from the provisioning system to the distributor line,
is connected, in terms of conveyance, to the buffer infeed line of the first buffer device and is configured to convey the loading aids from the distributor line to the first buffer device,
is connected, in terms of conveyance, to the target system and is configured to convey the loading aids from the distributor line to the target system, and
has a second distributor infeed line, which is connected, in terms of conveyance, to the buffer outfeed line of the first buffer device and is configured to convey the loading aids from the first buffer device to the distributor line.

2. The distributor system according to claim 1, wherein the distributor system has:
a first distributor outfeed line, which connects, in terms of conveyance, the distributor line and the buffer infeed line in order to connect, in terms of conveyance, the first distributor device to the buffer infeed line of the first buffer device, and/or
a second distributor outfeed line, which connects, in terms of conveyance, the distributor line and the target system.

3. The distributor system according to claim 1, characterized in that the provisioning system comprises at least one storage region and at least one loading station.

4. The distributor system according to claim 1, characterized in that the buffer region has at least one buffer line arranged between the buffer infeed line and the buffer outfeed line and at least one buffer return line arranged between the buffer outfeed line and the buffer infeed line.

5. The distributor system according to claim 1, characterized in that the target system has a workstation with a workstation infeed line, wherein the first distributor device is connected, in terms of conveyance, to the workstation infeed line and is configured to convey the loading aids from the distributor line to the workstation infeed line.

6. The distributor system according to claim 1, characterized in that the target system comprises a sorting device with a sorting infeed line, wherein the first distributor device is connected, in terms of conveyance, to the sorting infeed line and is configured to convey the loading aids from the distributor line to the sorting infeed line.

7. The distributor system according to claim 1, characterized in that the first distributor device is connected, in terms of conveyance, to a return line, which is configured to convey the loading aids back into the provisioning system.

8. The distributor system according to claim 1, characterized in that the distributor line is configured as a circulation circuit, wherein the loading aids can be conveyed in the circulation circuit in a direction of circulation.

9. The distributor system according to claim 8,
characterized in that a connection, in terms of conveyance, of the first distributor device to the buffer infeed line is arranged downstream of the first distributor infeed line and upstream of the second distributor infeed line in the direction of circulation.

10. The distributor system according to claim 8, characterized in that a connection, in terms of conveyance, of the first distributor device to the target system is arranged downstream of the second distributor infeed line and upstream of the first distributor infeed line in the direction of circulation.

11. The distributor system according to claim 1, characterized by
another buffer device, which has a buffer infeed line and a buffer outfeed line and at least one buffer region arranged between those; and
another distributor device, which has a first distributor infeed line that is connected, in terms of conveyance, to the provisioning system, a distributor line and a second distributor infeed line connected to the buffer outfeed line of the other buffer device,
wherein the other distributor device is connected, in terms of conveyance, to the buffer infeed line of the first buffer device and is configured to convey loading aids from the distributor line to the first buffer device,
and wherein each distributor device is additionally connected, in terms of conveyance, to the buffer infeed line of the other buffer device and is configured to convey loading aids from the respective distributor line to the other buffer device.

12. A method for provisioning at least one article included in an order in a target system of a picking system by a distributor system for conveying articles with loading aids, the method comprising the steps of:
i) acquiring orders and determining at least one article that is assigned to an order of the orders by means of an electronic order management system;
ii) provisioning the at least one article with at least one loading aid in a provisioning system;
iii) discharging the at least one loading aid from the provisioning system and forwarding the at least one loading aid into a first distributor device via a first distributor infeed line of the first distributor device;
iv) conveying the at least one loading aid along a distributor line of the first distributor device and transferring the at least one loading aid from the distributor line onto a buffer infeed line of a first buffer device;
v) forwarding the at least one loading aid into a buffer region of the first buffer device and temporarily storing the at least one loading aid in the buffer region;
vi) discharging the at least one loading aid from the buffer region via a buffer outfeed line of the first buffer device and transferring the at least one loading aid from the buffer outfeed line onto the distributor line of the first distributor device via a second distributor infeed line of the first distributor device;
vii) conveying the at least one loading aid along the distributor line and discharging the at least one loading aid from the distributor line;
viii forwarding the at least one loading aid to the target system.

13. The method according to claim 12, characterized in that the steps iv) to vi) are repeated with the same at least one loading aid in a second cycle before carrying out the step vii).

14. The method according to claim 13, characterized in that, in the second cycle, the steps iv) to vi) are carried out for another buffer device instead of the first buffer device.

15. The method according to claim 13, characterized in that, in the second cycle, the at least one loading aid, in the step vi), is transferred onto a distributor line of a second distributor device via a second distributor infeed line of the second distributor device.

16. The method according to claim 12, characterized in that, in the step i), at least one article that is assigned to another order of the orders is determined, wherein the steps ii), iii), vii) and viii) are carried out for the at least one article assigned to the second order while omitting the steps iv), v) and vi).

17. A method for provisioning articles included in an order in a target system of a picking system by a distributor system for conveying the articles with loading aids, the method comprising the steps of:
i) acquiring an order and determining a first order part, which comprises at least one article assigned to the order, which article is provisioned in a first provisioning region of a provisioning system of the picking system, and determining a second order part, which comprises at least one article assigned to the order, which article is provisioned in a second provisioning region of the provisioning system of the picking system, by means of an electronic order management system;
ii) provisioning the at least one article of the first order part with at least one first loading aid in the provisioning system and provisioning the at least one article of the second order part with at least one second loading aid in the provisioning system;
iii) forwarding the at least one first loading aid into a buffer device and temporarily storing the at least one first loading aid in the buffer device;
iv) determining a conveying duration for the at least one article of the second order part from the second provisioning region to a merging section, in which the at least one first loading aid and the at least one second loading aid are merged, by means of a control device;
v) releasing the discharge of the at least one first loading aid with the at least one article of the first order part from the buffer device by the control device on the basis of the determined conveying duration, so that the at least one first loading aid and the at least one second loading aid are merged in the merging section for the order;
vi) conveying the at least one second loading aid with the at least one article of the second order part from the second provisioning region to the merging section while bypassing the buffer device;
vii) discharging the at least one first loading aid from the buffer device and conveying the at least one first loading aid from the buffer device to the merging section;
viii) conveying the at least one first loading aid and the at least one second loading aid of the order from the merging section to a workstation in the target system.

18. The method according to claim 17, characterized in that the forwarding in step iii) comprises the following steps:
discharging the at least one first loading aid from the provisioning system and forwarding the at least one first loading aid into a first distributor device (3a) via a first distributor infeed line of a first distributor device;
conveying the at least one first loading aid along a distributor line of the first distributor device and transferring the at least one loading aid from the distributor line onto a buffer infeed line of the buffer device via a first distributor outfeed line.

19. The method according to claim 17, characterized in that the first provisioning region comprises a storage region and a loading station and the following steps are carried out in the step ii) for provisioning the at least one article of the first order part with at least one first loading aid:
retrieving the at least one article of the first order part from the storage region and
loading the at least one first loading aid with the at least one article of the first order part at the loading station.

20. The method according to claim 17, characterized in that the second provisioning region comprises a loading station and comprises the following step for provisioning the at least one article of the second order part with at least one second loading aid:
loading the at least one second loading aid with the at least one article of the second order part at the loading station.

21. A method for provisioning at least one article included in an order in a target system of a picking system by a distributor system for conveying the articles with loading aids, the method comprising the steps of:
i) acquiring an order, which is assigned at least one article, by an electronic order management system;
i) classifying the order in accordance with a classification criterion as a “sorting order” if a sorting of the at least one loading aid upstream of a workstation in the target system is required, or as a “non-sorting order” if the sorting of the at least one loading aid upstream of the workstation is not required, by the electronic order management system;
iii) provisioning the at least one article with at least one loading aid in a provisioning system;
iv) forwarding the at least one loading aid into a buffer device and temporarily storing the at least one loading aid in the buffer device;
v) discharging the at least one loading aid from the buffer device and forwarding the at least one loading aid to the target system;
vi) conveying the at least one article to the workstation, in particular by means of a conveying system of the distributor system, comprising:
either
forwarding the at least one loading aid into a sorting device if the at least one loading aid is assigned to a sorting order,
sorting the at least one loading aid by the sorting device,
forwarding the at least one loading aid from the sorting device to the workstation;
or
forwarding the at least one loading aid from the buffer device to the workstation while bypassing the sorting device if the at least one article is assigned to a non-sorting order.

22. The method according to claim 21, characterized in that the forwarding in step iv) comprises the following steps:
discharging the at least one first loading aid from the provisioning system and forwarding the at least one first loading aid into a first distributor device via a first distributor infeed line of a first distributor device;
conveying the at least one first loading aid along a distributor line of the first distributor device and transferring the at least one loading aid from the distributor line onto a buffer infeed line of the buffer device via a first distributor outfeed line.

23. The method according to claim 21, characterized in that the order is classified as a “sorting order” if the number of the articles, in particular of different types of article, assigned to the order is greater than one and the order is classified as a “non-sorting order” if the number of the articles assigned to the order is exactly one.

24. The method according to claim 12, wherein the distributor system utilized in the method is according to claim 1.

25. The method according to claim 17, wherein the distributor system utilized in the method is according to claim 1.

26. The method according to claim 21, wherein the distributor system utilized in the method is according to claim 1.
